(19) United States
(12) Patent Application Publication
(10) Pub. No.: US 2010/0196737 A1
(43) Pub. Date: Aug. 5, 2010

(54) PATTERNED BURNISH HEAD

(76) Inventor: Matthew P. Dugas, St. Paul, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 12/607,801

(22) Filed: Oct. 28, 2009

Related U.S. Application Data
(60) Provisional application No. 61/109,096, filed on Oct. 28, 2008.
(60) Provisional application No. 61/143,280, filed on Jan. 8, 2009.

(51) Int. Cl. G11B 5/33; B24B 7/00; B24B 1/00

(52) U.S. Cl. 428/800; 451/540; 451/28; 451/56

(57) ABSTRACT

The present disclosure relates to a burnishing head for processing the surface of a hard disk media. The burnishing head includes a body having cutting features comprised of a thin film material. In many embodiments, the thin film material may be diamond. In some embodiments, the cutting features may be features formed in the diamond film. In alternative embodiments, the cutting features may be features formed in the body and coated with a diamond film. In another embodiment, the present disclosure relates to a burnishing head including a body having a first surface having a well-behaved air bearing surface and a second surface having a plurality of burnishing pedestals for providing burnishing of a media surface. The pedestals include a plurality of micro cutting features etched therein. The present disclosure also relates to magnetic media made at least in part by using such a burnishing head.

### CROSS REFERENCE TO RELATED APPLICATIONS

This application claims priority to U.S. Provisional Patent Appl. No. 61/109,096, entitled “Patterned Diamond Burnish Head,” filed on Oct. 28, 2008, and to U.S. Provisional Patent Appl. No. 61/143,280, entitled “Patterned Diamond Burnish Head,” filed on Jan. 8, 2009, each of which is hereby incorporated by reference herein in its entirety.

### Field of the Invention

The present disclosure relates to burnishing heads for providing improved smoothening (burnishing) of hard disk information storage and retrieval media. Particularly, the present disclosure relates to burnishing heads having diamond coated surfaces or patterned diamond coated surfaces and methods for making such burnishing heads.

### BACKGROUND OF THE INVENTION

This disclosure relates to the field of hard disk drive (HDD), also known as hard drives and rigid disk drives, e.g., magnetic disks, magneto-optical (MO) disks, etc. More particularly, the present disclosure relates to the manufacture of the rigid magnetic disk used in HDD, typically where the disk platter is made of either an aluminum (Al) substrate, Al alloy substrate, or glass substrate. Where the disk is made of Al or an Al alloy, typically it will include a hard coat of nickel-phosphorus (NiP) plated on the Al disk in order to have a harder surface which can be polished to an atomically smooth surface. Substrates other than Al, Al alloy, or glass may be used and include, but are not limited to, ceramic substrates. In any case, the surfaces should be made very smooth and clean such that a thin film magnetic recording layer(s) may be deposited. These magnetic layers are typically deposited by sputtering and are typically made of a cobalt (Co) or iron (Fe) based alloy. A protective overcoat, typically a carbon formulation, is then applied on the magnetic film, and finally a lubricant layer is usually applied.

In depositing these magnetic thin films, complex or not, imperfections form on the surface as a natural result of various processes. Defects include, but are not limited to, asperities, voids, projections, debris, contaminants, or other protrusions or depressions. The defects that can be associated with crashes, reliability issues, and flying height management should be removed or they may result in damage to the read/write head or the disk. For example, thermal asperities (TAs) are asperities that cause thermal transients in the magnetic read/write recording head. These TAs degrade the recording heads, cause some tracks to be unusable, and can cause failure of the entire disk drive. Accordingly, magnetic disk manufacturing specifications typically require that asperities, protrusions, depressions, and other like imperfections on the surface of the disk are smaller than a specified size and character for a given recording system.

Accordingly, during the manufacturing process, testing and processes are carried out to characterize and remove these defects. Tests are typically performed with “glide heads,” or bump detection heads, to ensure that there are no defects present on the disk surface that might interfere with operation of the read/write head. Glide heads produce a signal based on strikes that hit the glide head. Glide heads are a test certification head. Asperities may be removed, however, by a technique known as burnishing. The object of the burnishing process is to remove asperities, particles, and debris while at the same time not damaging the delicate surface of the medium. Special heads, referred to herein as burnish heads, are used during the burnishing process to remove the asperities and positively displaced debris on the surface of the head. A typical certification process, therefore, may include a burnish head to remove the debris that is followed with a glide head to check and certify the absence of asperities and other defects.

Recording heads in disk drives fly over the spinning medium's surface at a specified flying height. As the information areal density is ever increasing, the flying heights are ever decreasing in order for the read/write heads to be a able to record and read the information from the magnetic medium, tending to dictate media with ultra-smooth surfaces and ultra-thin protective overcoat layers that minimize the head/disk separation and reduce flying height. For example, present technology approaches that of contact recording with flying heights in the 4 to 6 nanometer (nm) range. Asperities and their elimination can play a critical role in reliability at these distances.

Accordingly, burnish head technology should evolve to keep pace with the areal density requirements of the industry. Conventional burnish heads have comprised either waffle patterns (e.g., patterns of elliptically-shaped discrete projections or pads) or rail-type designs that were processed into the entire slider surface to form cutting edges which would remove the debris or asperities with a skiving action. More recently, an example hybrid burnish head, having a combination of surfaces that a) has first major surface features to form a well behaved air bearing surface and b) second major surfaces that provide for the burnishing of the media, has been introduced in U.S. Pat. No. 7,255,636, which is hereby incorporated by reference herein in its entirety. While such a hybrid head may have advantages over more conventional burnish heads, it does not have sophisticated cutting features or cutting materials on its surface.

As critical layer thicknesses and critical feature sizes become ever smaller and smaller, more sophisticated burnishing heads are desired. Notwithstanding the advances in burnish head technology that have been made, with the ever decreasing flying height and the ever improving magnetic media, and in light of the foregoing discussion, there exists a need for yet more advanced burnishing heads. Particularly, there exists a need for burnishing heads having diamond coated surfaces or patterned diamond coated surfaces and methods for making such burnishing heads. There further exists a need for a burnish head having an electric heater on the trailing edge to extend the cutters more deeply into the nanometer range asperity field.

### BRIEF SUMMARY OF THE INVENTION

The present disclosure, in one embodiment, relates to a burnishing head for processing the surface of a hard disk media. The burnishing head includes a body having cutting features comprised of a thin film material. In many embodiments, the thin film material may be diamond. In some embodiments, the cutting features may be features formed in the diamond film. In alternative embodiments, the cutting features may be features formed in the body and coated with a diamond film. The present disclosure, in another embodiment, relates to magnetic media made at least in part by using a burnishing head, as described above.

The present disclosure, in yet a further embodiment, relates to a method of burnishing a rigid disk. The method may include providing a burnishing head, such as the burnishing head described above and removing asperities in a surface of the rigid disk using the cutting features of the burnishing head.

The present disclosure, in still another embodiment, relates to a burnishing head for processing the surfaces of hard disk media. The burnishing head includes a body having a first surface having a well-behaved air bearing surface and a second surface having a plurality of burnishing pedestals for providing burnishing of a media surface. The pedestals include a plurality of micro cutting features etched therein.

While multiple embodiments are disclosed, still other embodiments of the present disclosure will become apparent to those skilled in the art from the following detailed description, which shows and describes illustrative embodiments of the disclosure. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the embodiments will be better understood from the following description taken in conjunction with the accompanying Figures, in which:

FIG. 1 is a plan view of a burnishing head according to an embodiment of the present disclosure.

FIG. 2 is a plan view of another embodiment of a burnishing head according to an embodiment of the present disclosure showing a ramped leading edge.

FIG. 3 is a cross-section view of a burnishing head according to an embodiment of the present disclosure in operation.

FIG. 4a is a side cross-section view of a cutting feature according to an embodiment of the present disclosure showing a burnishing pad with a cutting facet, wherein the diamond cutting film edge is processed to be adjacent to the cutting facet edge.

FIG. 4b is a side cross-section view of a cutting feature according to an embodiment of the present disclosure showing a burnishing pad with a cutting facet, wherein the diamond cutting film edge is processed to be at a distance away cutting facet edge.

FIG. 4c is a side cross-section view of a cutting feature according to an embodiment of the present disclosure showing a burnishing pad with a cutting facet, wherein the diamond cutting film edge is deposited over the entire field of features.

FIG. 4d is a side cross-section view of a burnishing pad according to an embodiment of the present disclosure wherein the natural roughness of the diamond film provides the cutting features.

FIG. 5 is a perspective view of a burnishing head according to an embodiment of the present disclosure comprising a heater element at the trailing end of the head.

### DETAILED DESCRIPTION

The present disclosure relates to novel and advantageous burnishing heads for providing improved smoothening (burnishing) of hard disk information storage and retrieval media. Particularly, the present disclosure relates to novel and advantageous burnishing heads having diamond coated surfaces or patterned diamond coated surfaces and methods for making such burnishing heads. The present disclosure further relates to burnishing heads having an electric heater on the trailing edge to extend the cutters more deeply into the nanometer range asperity field.

In one embodiment, a diamond coated wafer may be photolithograpically patterned and etched into a wafer of diamond surface facets and may then be singulated into slider bodies, each slider body containing an area of diamond facets. A slider body may contain two major sets of surfaces, one surface set which helps control the flying height stability and the other surface set may provide burnishing actions. Although not necessary, for process simplicity, diamond can be deposited on all surfaces. On the surfaces that are dedicated to burnishing, the diamond layer facets can be made in large numbers and can be shaped or patterned for cutting or burnishing. On the surfaces that are dedicated to flying height stability and which form the major air bearing surfaces, the diamond layer may remain un-patterned. The slider bodies may then be mounted onto suspensions. The various embodiments of the present disclosure also allow for a heater element on the trailing edge of the slider, stepped air bearing surfaces, cutting facets provided on the air bearing surfaces, and/or the magnetic capture of cut and shed debris.

The various embodiments of the present disclosure address and improve some of the technical issues with the current generation of burnishing heads and improve the performance of burnishing technology, assist and contribute to the manufacture of higher areal density media and drives, and remain compatible with the automated manufacturing processes that are currently used. Moreover, the present disclosure may contribute to planarization and CMP processes in other fields such as that of semiconductors.

One advantage of the various embodiments of the present disclosure includes that diamond is the hardest substance found in nature. Another advantage of the various embodiments of the present disclosure includes that the diamond layer can be patterned into discrete diamond cutting features or cutters, forming micro cutter shapes for the burnishing application. Yet another advantage of the various embodiments of the present disclosure includes the slider body having well controlled flying characteristics. A further advantage of the various embodiments of the present disclosure includes the slider body may be fitted with a heater element on the trailing edge, such that the patterned diamond cutters may be brought into an intimate and controllable contact with the defects of the medium. Yet a further advantage of the various embodiments of the present disclosure includes that planar technology and advanced semiconductor fabrication processes may be used to create precision cutting surface features in combination with precision air bearing surface features. Additional advantages and other features of the various embodiments of the present disclosure are set forth in that which follows and will become apparent to those having ordinary skill in the art upon examination of the following or may be learned from the practice of the present disclosure.

FIG. 1 shows a plan view of a burnishing head 100 according to one embodiment of the present disclosure. Burnishing head 100 may include an air bearing surface (ABS) area comprising rails 115a, 115b, and 115c, which can serve to provide for a stable flying height of the head 100. Burnishing head 100 may also include an area 110 for burnishing actions, including a plurality of raised burnishing pedestals or pads 120. Burnishing pads 120 may be made to have a generally circular or elliptical cross-sectional shape or any other suitable or desirable cross-sectional shape, such as but not limited to, a square or diamond. However, the pads 120 may generally have a cross-sectional shape that tends not to diminish the flying height stability of the head as a whole. The burnishing pads may be evenly distributed in area 110 or may be unevenly or randomly distributed in area 110. The head 100 may have a typical length dimension 105 on the order of from about 1.2 to 2 mm and a typical width dimension 106 on the order of from about 1.0 to 1.6 mm.

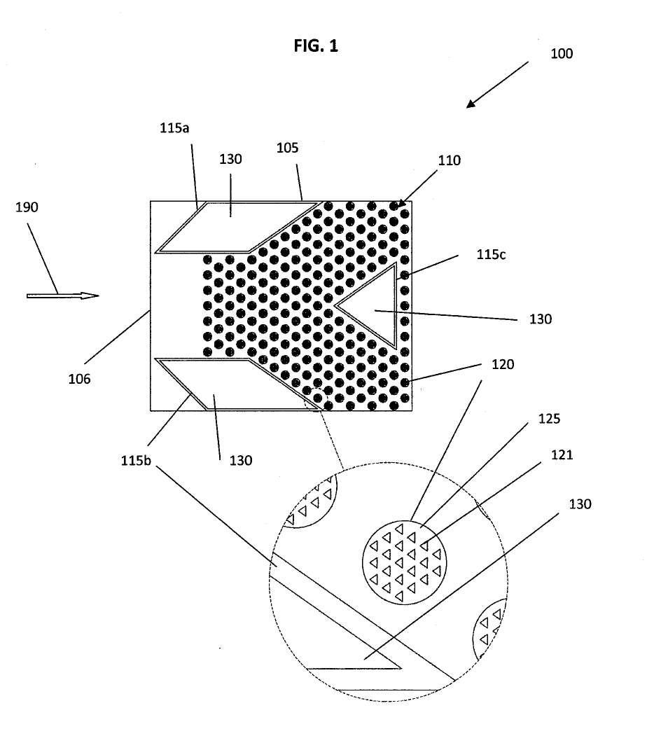

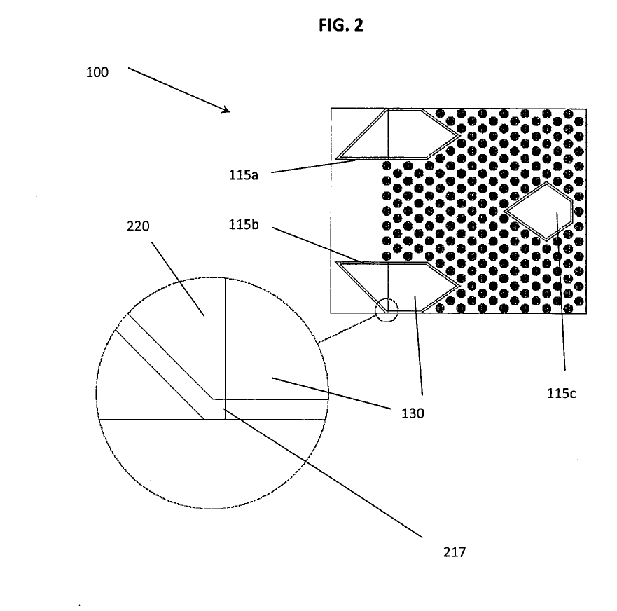

The design configuration for rails 115 and burnishing area 110 illustrated in the figures is not meant to be limiting, and is for illustrative purposes only. Indeed, it is recognized that many different design configurations for rails and a burnishing area or areas may be utilized, including the different configurations disclosed in U.S. Pat. No. 7,255,636, which was previously incorporated by reference. Similarly, the number, shape, arrangement, spacing, and area occupied by the burnishing pads 120 may be varied and selected for a particular burnishing application. Further, the number, polygonal shape, and positioning of each of the rails 115 can be varied and may involve angled, e.g., triangular, parallelepiped, or rectangular/square configurations. For example, in one embodiment, the trailing edge rail 115c may be optional and represents the region of the largest surface area of closest approach to the disk surface. Without the trailing edge rail 115c, the head may be referred to herein as a pure catamaran style head. Additionally, the side ABS rails 115a, 115b may extend the full length of the slider in either case. In another example, illustrated in FIG. 2, a burnish head may include one or more leading edge ramps or steps. Particularly, in one embodiment, a burnishing head 100 may include ABS rails 115a, 115b that have leading edge ramp regions 220, as defined by the line of slope change 217. Further yet, while described mainly with regard to a hybrid style burnishing head, it is understood that some or all of the features of the present disclosure can apply equally well to conventional burnish heads comprised of waffle patterns or rail-type designs.

The surface of the burnish pads 125 and the rails 130 may be coated with a diamond film, such as a CVD diamond film. In one embodiment, the diamond on the burnish pads 120 may be patterned to form diamond cutting features or cutters 121 on the surfaces 125 of the pads. The cutters 121 may be patterned in any suitable or desirable shape, including but not limited to, wedge-shaped, pyramidal, or polygonal. However, the shape of the cutters 121 may generally be shaped to allow or direct the removal of debris cut or removed from the surface of the media. In one embodiment, cutters 121 may be patterned in the diamond film only on the surfaces 125 of the burnishing pads 120. The diamond on the ABS rail surfaces 130 may be left un-patterned. In other embodiments of the disclosure, however, cutters may also be patterned on one or more of the ABS rail surfaces 130 in a similar manner.

In alternative embodiments, the diamond film on the surfaces of the burnish pads 125 and/or the rails 130 may be left un-patterned, but the diamond film may be deposited to a thickness to achieve a desirable amount of natural texture, or roughness, in the surface of the diamond film which may be used in place of patterned cutting features or cutters 121. Roughness may be used herein to refer to a height measurement from a peak in the diamond surface to a valley, or void, in the diamond surface. In chemical vapor deposition (CVD) diamond, the deposited diamond may naturally have a surface roughness of about 10% of its thickness. Accordingly, a desired roughness can be achieved by depositing a diamond film having a correlating thickness. For example, a roughness of about 10-20 angstroms can be achieved by depositing a diamond film having a thickness of about 100-200 angstroms.

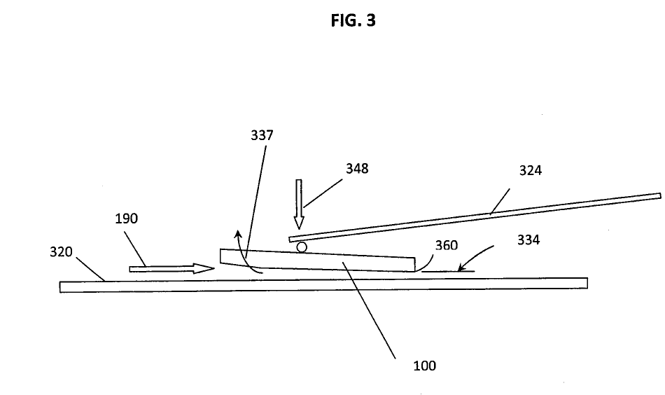

Generally, a disk medium passes by the head 100 in a direction from left (e.g., from the leading edge of the head) to right (e.g., toward the trailing edge of the head) as shown by the directional vector 190. FIG. 3 is a schematic representation of one embodiment of a burnish head during operation, passing over a media surface 320. Burnish head 100 generally “flies” over the media surface 320 at a predetermined flying height 334. A preload force 348 from the suspension member 324, and its location on the back of the slider, sets the mechanical boundary conditions of the system. The flying height 334 is typically measured from the disk surface 320 to the trailing edge 360 of the head 100. Pitch moment 337 serves to keep the head stable and well behaved with the trailing edge 260 at the closest distance from the media surface 220. If a heater element is included, as will be described in further detail below, leads to the heater element on the trailing edge of the slider may be used to provide voltage/current to the heater element.

Fabrication processes for making a burnish head according to the various embodiments disclosed herein may use advanced manufacturing techniques such as chemical vapor deposition, sputtering, evaporation, photolithography, ion milling, and reactive ion etching (RIE) among other processes, including but not limited to micro-machining. Both wafer scale process and/or row-bar scale processes may used to fabricate a burnishing head 100 of the present disclosure. If the embodiment includes a heater element, as described in detail below, then a combination of both processes may be used.

CVD deposited diamond films grow well on silicon, and diamond coated silicon is readily available in the commercial market. Accordingly, while not limited to silicon, silicon can be one of the preferred substrates of this disclosure. Other suitable substrate materials, such as but not limited to, alumina-titanium carbide (Al2O3TiC), silicon carbide (SiC), silicon dioxide (SiO2), sapphire, and aluminum oxide (Al2O3) are to be considered fully within the scope of this disclosure.

In one fabrication process for making a burnish head according to the various embodiments disclosed herein, the ABS rails and burnishing pads may be lithographically etched in the substrate. In one embodiment, this may be done by applying a photoresist, curing/pre-baking the photoresist, as necessary, exposing and developing the photoresist, curing/post-baking the photoresist, and etching, such as by ion milling, the ABS rail configuration.

A diamond film may be deposited onto the resulting substrate. As stated above, the diamond may be left un-patterned and the natural roughness of the diamond film may be used in place of diamond cutting features or cutters 121. In such an embodiment, if desired, an etching step, such as a RIE step, may be used on the diamond film to expose the surface roughness of the diamond to etching, which can reduce the roughness of the diamond film. In this regard, the roughness of the diamond film may be tailored to a specific roughness and application. If the diamond film is to be patterned, a photoresist may be applied, cured/pre-baked, as necessary, exposed and developed, and cured/post-baked. The head may then be etched, such as by using reactive ion etching (RIE), ion milling, or other suitable etching processes, to form the diamond cutting features or cutters 121 in the diamond film. In some embodiments, an intermediate step of selective etching with a hardmask, for example but not limited to, of SiO2 or Al, may be used or appropriate. In such a case, the hardmask can then be chemically etched off the head. In further embodiments, after discrete diamond patterning, an additional etching step, such as a RIE step, may be used on the resulting patterned diamond cutters 121 to expose the surface natural surface roughness of the diamond to an etching process, such that the natural roughness of the diamond may be tailored or smoothed to a specific or desired texture and/or for a specific application, as may be desired.

A burnishing head as described herein may be patterned and processed in its entirety or in sub-parts thereof, and the diamond may be coated over these features and around the edges of these features. In some embodiments, the diamond features may be patterned proper, as described above. In other embodiments, the diamond may be blanket coated over pre-patterned air bearing features and/or cutting features, which can eliminate the need to pattern the diamond film itself That is, the body of the head may be partially or completely patterned with cutters before the diamond is deposited, nonetheless resulting in diamond coated cutters 121. In the case of patterning the head body before the diamond is deposited, the resulting step coverage of the deposited diamond on the side of the walls may promote more aggressive cutting of the asperities. In the case of depositing and patterning the diamond independently of patterning other ABS and cutter features, the diamond patterned by the etch process may have intrinsic side walls which may serve as useful cutting features. These and other variations are to be considered completely within the spirit and scope of this present disclosure.

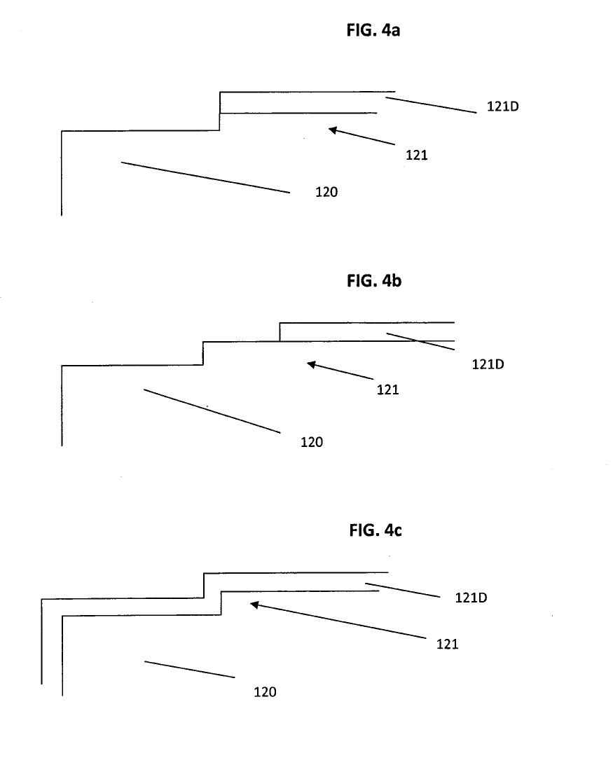

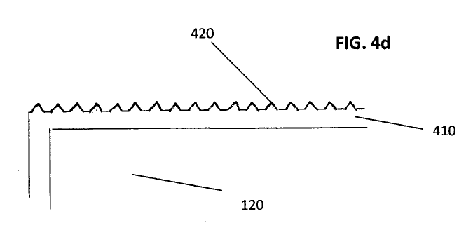

FIGS. 4a-d show various embodiments of a cross-section of a burnish pad 120 of FIG. 1 according to different fabrication methods. In FIG. 4a, a diamond cutter 121 is shown with the diamond 121D on top of the cutter feature as having been patterned after diamond deposition and in the same etch process or in a mask alignment operation that places the two layered features, 121 and 121D, on top of one another. In FIG. 4b, a diamond cutter 121 is shown with the diamond etched during a different etch step, resulting in the diamond edge positioned away from a micro cutter edge of the burnish pad 120. In FIG. 4c, a diamond film is shown as having been deposited on the burnishing pad 120 surface after the pedestal and a micro cutter feature have been etched into the pad. The diamond deposition 121D of FIG. 4c was performed after the slider ABS and micro cutter feature were fabricated. FIG. 4d illustrates an embodiment where a burnishing pad 120 has not been patterned with a cutter 121, instead using the natural roughness 420 of the diamond film 410 as cutters, as described in detail above. While illustrated in detail only in FIG. 4d for ease of illustration, it will be noted that the diamond cutters of any of FIGS. 4a-c may also include a natural roughness of the diamond film.

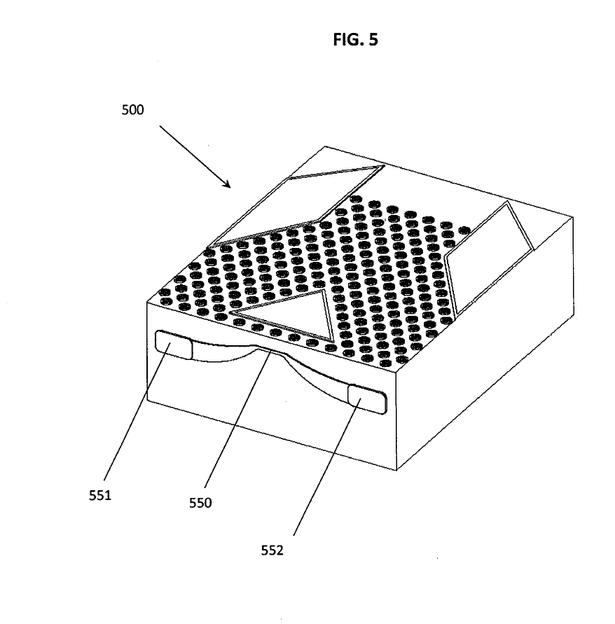

FIG. 5 shows an embodiment of a burnishing head 500 of the present disclosure further including a trailing edge heater element 550 with the associated lead pads 551 and 552. The trailing edge heater 550 allows for thermal growth of the trailing edge of the slider so as to land the cutters of the head 500 generally precisely onto asperities. The heater system may be used in further combination with acoustic emission feedback to land the cutters onto the asperity surfaces. However, other feedback mechanisms to land the cutters onto asperities are considered fully within the scope of this disclosure.

More specifically, in one embodiment, a heater 550 may be designed and located at the trailing edge of the burnish head 500 to enable controlling the interference between the burnish head and the asperity. A heater 550 according to one embodiment may be a thin film heater element. Upon applying a current to the thin film heater 550, the trailing edge may protrude and cause a loss in clearance between the head 500 and the disk. The amount of protrusion can be calibrated with the aid of an acoustic emission sensor capable of sensing contact between asperities and the burnish head. The amount of interference can be calibrated by developing a transfer function relating the acoustic energy emitted by the acoustic emission sensor to the head contact with the asperities. Interference control may be accomplished by the use of a variable power supply and circuit connected to the heating element in combination with the use of techniques such as acoustic emission feedback. In another embodiment, capacitors on the ABS may be incorporated as a technique for measuring the flying height in order to drive the heater element.

Standard thin film technology may be used to fabricate the heater as shown in U.S. Pat. No. 5,991,113, which is hereby incorporated by reference herein in its entirety. For example, in one fabrication process for adding a heater element to a burnish head according to the various embodiments disclosed herein, a material, such as a suitable electrically conducting material, for the heater element 550 may be deposited at the appropriate location at the trailing end of the head 500. A photoresist may then be applied, cured/pre-baked, as necessary, exposed and developed, and cured/post-baked. The heater element may then be etched in the heater element material deposited on the head. The process may be repeated if separate bond tabs for the leads of the heater element are desired. The photoresist may then be stripped or etched off

What has been disclosed herein are micro cutting patterns which are developed using planar processing technologies to form micro cutters or micro cutting features on burnishing pads. The micro and nano tribology of such state of the art slider bodies is a complex area of science and technology. While diamond may appear to be one desirable film, and is discussed in detail herein, it is recognized that any other suitable materials may be used, such as but not limited to diamond-like carbon, with a combination of Sp2 and Sp3 chemical bonds, which is a natural polycrystalline thin film. Virtually any thin film may be used for this purpose if found to be suitable or desirable for the burnishing application desired.

In addition to the thin film cutters disclosed herein, such as the thin film cutters made of diamond film or other film or coated with a diamond film or other film, in alternative embodiments, cutters may be formed in the burnishing pads and/or rails of the head substrate without having a diamond film coating. Such an embodiment would be similar to that illustrated in FIG. 1, but for the diamond film.

Although the various embodiments of the present disclosure have been described with reference to preferred embodiments, persons skilled in the art will recognize that changes may be made in form and detail without departing from the spirit and scope of the present disclosure.

We claim:

1. A burnishing head for processing the surface of a hard disk media, comprising a body comprising cutting features comprised of a thin film material.

2. The burnishing head of claim 1, wherein the thin film material is diamond.

3. The burnishing head of claim 1, wherein the cutting features comprised of diamond film comprise features formed in the diamond film.

4. The burnishing head of claim 1, wherein the cutting features comprised of diamond film comprise cutting features formed in the body and coated with the diamond film.

5. The burnishing head of claim 4, wherein the diamond film substantially covers the cutting features formed in the body to form cutting features with diamond coated facets.

6. The burnishing head of claim 1, wherein the cutting features result from the natural roughness of the diamond film.

7. The burnishing head of claim 1, wherein the body comprises:
first and second surfaces, wherein the first surface is configured to provide a well-behaved air bearing surface and the second surface is configured for providing burnishing of a media, the second surface comprising the cutting features.

8. The burnishing head of claim 7, wherein the first surface comprises rails adjacent the second surface, and the second surface is comprises a plurality of burnishing pads, each comprising a cutting feature.

9. The burnishing head of claim 8, wherein the first surface is coated with a diamond film.

10. The burnishing head of claim 8, wherein the first surface comprises cutting features comprised of diamond film.

11. The burnishing head of claim 8, wherein the burnishing pads have an elliptically-shaped cross-section.

12. The burnishing head of claim 1, further comprising a heater element at the trailing end of the body.

13. The burnishing head of claim 12, further comprising a power supply and circuit operably connected to the heating element for controlling the flying height of the trailing end of the body.

14. Magnetic media made at least in part by using a burnishing head, comprising a body comprising cutting features comprised of thin film material, to remove asperities in a surface of the magnetic media.

15. A method of burnishing a rigid disk comprising:
providing a burnishing head comprising a body comprising cutting features comprised of thin film material; and
removing asperities in a surface of the rigid disk using the cutting features of the burnishing head.

16. The method of claim 15, wherein the step of providing a burnishing head comprises depositing a diamond film on the body and etching cutting features in the diamond film.

17. The method of claim 15, wherein the step of providing a burnishing head comprises etching cutting features in the body and coating the features with a diamond film.

18. The method of claim 15, wherein the step of providing a burnishing head comprises depositing a diamond film such that the natural roughness of the diamond film forms the cutting features.

19. The method of claim 15, wherein the burnishing head further comprises a heater element at the trailing end of the body and using the heater element to control the flying height of the trailing end of the body.

20. A burnishing head for processing the surfaces of hard disk media, comprising:
a body including first and second surfaces, wherein:
the first surface includes a well-behaved air bearing surface; and
the second surface includes a plurality of burnishing pedestals for providing burnishing of a media surface, the pedestals comprising a plurality of micro cutting features etched therein.
